(19) United States
(12) Patent Application Publication
(10) Pub. No.: US 2003/0220859 A1
(43) Pub. Date: Nov. 27, 2003

(54) Method and system for investing with a no-loss or low-loss assurance

(76) Inventor: Herbert Cohen, North Potomac, MD (US)

Correspondence Address: NOTARO AND MICHALOS, 100 DUTCH HILL ROAD, SUITE 110, ORANGEBURG, NY, 10962-2100, US

(21) Appl. No.: 10/338,124

(22) Filed: Jan. 7, 2003

Related U.S. Application Data
(63) Continuation-in-part of application No. 10/154,143, filed on May 22, 2002.

(51) Int. Cl. G06F 17/60

(52) U.S. Cl. 705/35

(57) ABSTRACT

A method for investing with a no or low-loss assurance, provides a plurality of risk levels. A feasibility analysis is performed to determine a positive percent of profit. The agent purchases an equity with a money packet of the investor based on whether the equity can conform to a gain sale threshold which achieves the goal of the feasibility analysis. When one of the sale thresholds is reached, the equity is sold. If a gain sale threshold is reached, the gain is apportioned between the investor and the agent according to the selected risk level. The method repeats the steps of purchasing an equity, selling the equity when a sale threshold is reached and apportioning the gain between the investor and the agent, until the sale threshold is a loss sale threshold. The loss is apportioned between the investor and the agent based on the selected risk level.

### CROSS-REFERENCE TO RELATED APPLICATION

The present application is a continuation-in-part of U.S. application Ser. No. 10/154,143 filed on May 22, 2002, from which priority is claimed, the entirety of which is hereby incorporated by reference.

### FIELD AND BACKGROUND OF THE INVENTION

The present invention relates generally to investing, and, more particularly, to a method and system of investing which provides the investor with a no-loss or a low-loss assurance.

Traditionally, investing has been difficult for the typical investor, particularly when the investor wishes to invest in a number of different investments for purposes of diversification but has a limited amount of funds to invest. The problem is exacerbated by the fact that most investors have neither the understanding nor the resources to properly measure the risk and return of investments.

Considering investment in stocks as illustrative of the general problem posed above, the advent of stock mutual funds in recent years has made it substantially easier for the investor to achieve the goal of diversification on a limited budget. The fact that a fund manager assumes the responsibility, which would otherwise be the investor's, of researching and trading the stocks of individual companies has made investing in the stock market more convenient.

Nonetheless, individual investors, as well as institutional investors, still face the inherent risk relating to the possibility of a loss in invested capital. Parameters for buying and selling are still insufficient. A system of controls is needed for increasing the frequency of gains and decreasing the frequency of loss. Parameters are needed for investment guidance within feasible or realistic boundaries.

### SUMMARY OF THE INVENTION

It is an object of the present invention to provide a method and system of investing which protects the investor from a loss of invested capital.

It is also an object of the present invention to provide a method of investing which offers a no loss assurance to the investor.

It is a further object of the present invention to provide feasible parameters or boundaries for guiding investment decisions.

It is yet a further object of the present invention to provide a system for checking whether particular investments conform with tested feasible parameters.

Accordingly, the invention provides a method for an investor to invest an amount of money, here called a money packet, with the aid of an agent, and with a no or low-loss assurance, depending on one of a plurality of risk levels selected by the investor. Each risk level has a gain apportionment value and a loss apportionment value which dictate an apportionment of a gain and a loss, respectively, between the investor and the agent. Each risk level also includes a gain sale threshold and a loss sale threshold. A risk level is selected for investing the money packet.

A feasibility analysis is then performed before the purchase of an equity to determine a positive packet percent of profit. Parameters are first assigned that are consequential to an investment outcome, such as gain sale threshold. A combination of loss to gains per combo is selected. An investor's combo net profit is determined. The investor's combo net profit over a plurality of combos is then projected. Finally, the projected combo net profit can be used to determine a percent of profit for the money packet. If the percent of profit is a negative value, or a loss, the gain sale threshold or the combination of loss to gains per combo is adjusted, and the feasibility analysis is repeated until the percent of profit is a positive number, or a gain.

Specific equities are checked for conformity with the gain sale threshold that results in a positive percent of profit in the feasibility analysis. An equity is purchased with the money packet. Upon reaching one of the sale thresholds, the equity is sold to complete a cycle or transaction of a combo, or combination of transactions. If the sale threshold reached is a gain sale threshold, the gain is apportioned between the investor and the agent according to the gain apportionment value of the selected risk level. The investor's apportioned gain is added to the money packet thereby increasing its value. The method repeats the steps of purchasing an equity with the money packet, selling the equity when a sale threshold is reached and apportioning the gain between the investor and the agent according to the gain apportionment value, until the sale threshold is a loss sale threshold. A loss sale threshold ends the combo. The loss is apportioned between the investor and the agent according to the loss apportionment value of the selected risk level and the investor's apportioned loss is subtracted from the money packet.

The various features of novelty which characterize the invention are pointed out with particularity in the claims annexed to and forming a part of this disclosure. For a better understanding of the invention, its operating advantages and specific objects attained by its uses, reference is made to the accompanying drawings and descriptive matter in which a preferred embodiment of the invention is illustrated.

### BRIEF DESCRIPTION OF THE DRAWINGS

In the drawings:

FIG. 1 is a block diagram of the steps for managing a money packet investment;

FIG. 2 is a block diagram of the steps for performing a feasibility analysis before the purchase of an equity;

FIG. 3 is a block diagram of the steps for performing a feasibility analysis for an agent and an investor, when the agent cannot collect commissions directly from the investor.

### DESCRIPTION OF THE PREFERRED EMBODIMENTS

In accordance with the present invention, an investor invests a sum of money into equities through an agent. The agent bears a portion or all of any realized loss in the invested sum, thus providing a safe, no-loss or low-loss assurance to the investor. An agent is any person or entity which transacts the sale and purchase of equities on behalf of the investor, such as a broker. The type of equities which an agent can purchase with the investment sum include, but certainly are not limited to, stocks, stock options, bonds, money market funds, real estate, mutual funds or any other equity that has recognized predictability in its potential for gain.

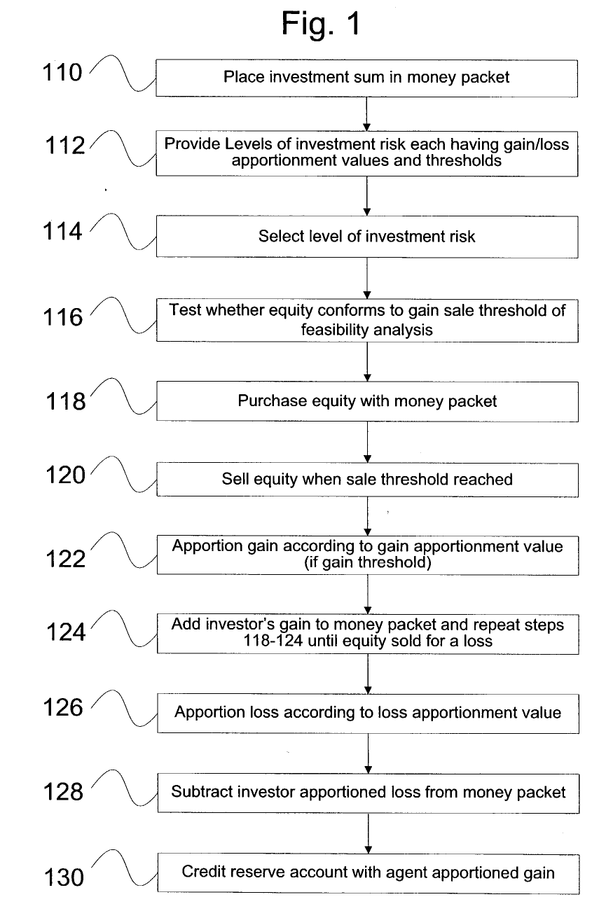

Referring to the drawings, FIG. 1 shows a process flow diagram of operation of an investment method with a selected loss assurance.

At step 110, an investment sum is provided to an agent for investing into equities. The investment sum, for example $10,000, is called a money packet and is placed into a money packet account. The money packet has an identification code that matches the money packet to the investor. The money packet is invested during a sequence of transactions that may yield any number of gains but only one last loss. Each sequence of such transactions is here called a combo. A combo is a combination of transactions which may be a single loss, or one or more gains in a series of transactions that ends with a loss. The loss transaction ends a prior combo and starts the next, new combo.

At step 112, the invention provides the investor with a plurality of levels of investment risk. Each level of investment risk has a pre-designated gain apportionment value and a pre-designated loss apportionment value. The apportionment values determine the apportionment of any gain or loss, respectively, between the investor and the agent realized from transactions using the money packet. Each level also has a gain threshold that dictates when the equity must be sold to realize a gain, and a loss threshold which likewise dictates when the equity must be sold to realize a loss.

For example, Level 1 has a gain apportionment value for the investor of 12% and a loss apportionment value for the investor of 0% (no-loss assurance). The agents gain apportionment value is 88% but his/her loss apportionment value is 100%. The gain threshold is 4% and the loss threshold is 2%.

If Level 1 is selected, the agent, using known research tools, will identify an equity, e.g. a stock, that is likely to gain over 4% in the short run, e.g., a stock that is expected to gain 6% within the next few weeks. All of the money in the packet is then used to purchase as much of the selected stock as needed to use up the packet. This starts the first transaction in a combo. If the stock rises by 4%, all of the stock is sold. Following the requirements of Level 1, 12% of this gain is credited to the investor and added to the packet for the next transaction. 88% of the gain is credited to the agent and removed from the packet. The packet is then used to purchase the same or a different equity. The only limitation is that the equity must be expected to make the 4% or better gain, at least in the short run. If, however, the stock price falls by 2%, all of the stock must be sold and the loss apportioned to the agent (100% loss to agent or no-loss assurance to investor). The agent must credit the loss to the packet thereby returning the packet to its prior value. The combo ends and a new combo begins with the next transaction.

Level 2 may have a gain threshold of 4.8 to 6%, for example, a loss threshold of 2%, an investor gain apportionment of 45% (agent gain apportionment 55%), and a loss apportionment (low-loss assurance) of 50%. Level 3 may correspond, for example, to the prior art in that an aggressive gain of over 10% is sought, with the gain and loss apportionments for the investor being 100% in both cases. If this level is selected the agent is paid a commission for the transactions and does not share either in any gain or in any loss. If any loss-assurance level is selected the agent receives no additional commission but rather shares in the gain.

Thus, depending on the level selected, the apportionment values determine the apportionment of any gain or loss, respectively, between the investor and the agent realized from transactions using the money packet. Each level also has the gain threshold that dictates when the equity must be sold to realize a gain, and the loss threshold which likewise dictates when the equity must be sold to realize a loss.

The investor selects the level of investment risk to be assigned to the money packet at step 114. The level of investment is selected based on the desired level of return and the risk aptitude of the investor. An investor who is willing to bear a high level of risk can select a level of investment which provides a larger apportionment of realized gain but also a larger apportionment of realized loss to the investor. An investor who is not willing to accept a high level of risk can select a level of investment which provides a smaller apportionment of any realized gain but a zero or a smaller apportionment of any realized loss to the investor.

Each level of investment also has the pre-designated gain sale threshold and pre-designated loss sale threshold. The pre-designated gain sale threshold corresponds to an increase in the value of a purchased equity or a profit which would be realized from a sale of the equity. The pre-designated loss sale threshold corresponds to a decrease in the value of the purchased equity. The sale thresholds initiate the sale of the equity. When the current market value of an equity purchased with the money packet reaches one of the sale thresholds, the agent must sell the equity.

Table 1 below is an exemplary table of the levels of investment and their respective predesignated apportionment values and sale thresholds.

| | Gain | Loss | Investor's | Investor's | |
|---|---|---|---|---|---|
| | Threshold | Threshold | Gain | Loss | |
| Level | (%) | (%) | (%) | (%) | Summary |
| 1 | 4 | 2 | 12 | 0 | no loss assurance, |
| | | | | | no commission |
| 2 | 6 | 2 | 45 | 50 | no commission |
| 3 | 10 | 2 | 100 | 100 | investor trades |
| | | | | | only, |
| | | | | | commissions |
| | | | | | paid |

Level 1 provides a no-loss assurance to the investor. 12% of any realized gain is apportioned to the investor, while the remaining 88% of the realized gain is apportioned to the agent. The investor, however, does not bear realized loss and pays no commission to the agent on any transactions using the money packet. Under Level 1, the agent must sell an equity purchased with the money packet if the equity's current market value is at least 4% higher or at least 2% lower than the purchase price of the equity. An investor who selects Level 1 will receive the lowest apportioned gain but will not bear any loss in the value of the money packet.

Level 2 provides a riskier investment style. The investor will receive 45% of any realized gain (higher than in Level 1) but will also bear 50% of any loss. A Level 2 investor will not pay a commission to the agent on any transaction using the money packet. It is likely that the type of equities purchased under Level 2 will be riskier than the type of investments purchased under Level 1 since the Level 2 has a higher gain threshold—6%. Thus, the agent must wait until the equity's current market value is at least 6% higher than the purchase price of the equity to sell the equity.

Level 3 provides the traditional investment arrangement to investors as known in the prior art. The investor receives 100% of any realized gain, bears 100% of any realized loss and pays a commission to the agent on any transaction using the money packet.

In step 116, an agent uses the gain sale threshold of a feasibility analysis to test whether a stock can conform to a particular gain sale threshold. Stock spread is analyzed to determine conformity with a particular gain sale threshold. An agent researches stocks in their cyclical patterns within their recent historical point spread, analyzing those stocks that are in an upward trend but in the dip phase of their cycle. The agent chooses a stock. A recent upper point spread is recorded. A quote price is determined by searching stocks for a preset percentage of profit. The difference between the upper point spread and the quote price is the spread value. The spread value divided by the quote price is the net point spread percentage. If the net point spread percentage is equal to or greater than the predetermined gain sale threshold from the feasibility analysis test, the stock is considered for a buy.

At step 118, the agent purchases an equity with the money packet on behalf of the investor. As is well known in the prior art, the agent conducts an analysis to determine which equity corresponds to the selected level of investment or which will have a projected value that correspond to the gain sale threshold. For example, with respect to stocks, the agent researches the cyclical patterns of a stock's price. A stock that meets the profit criteria of the selected level is considered for a purchase.

At step 120, the equity is sold when either a gain or loss sale threshold is reached. The sale completes the first cycle or transaction of the combo.

If the sale threshold reached is a gain sale threshold, the gain is apportioned between the investor and the agent according to the gain apportionment value of the selected level of investment at step 122.

The investor's apportioned gain is added to the money packet at step 124.

Steps 118, 120, 122, and 124 are repeated until the equity is sold for a loss, which means that the loss sale threshold has been reached. The equity purchased at step 118 can be the same or different from a prior purchased equity. The money packet used to purchase the equity includes the original investment sum and any apportioned inventor's gain added thereto from a prior sale in the combo.

At step 126, the loss is apportioned between the investor and the agent according to the loss apportionment value.

The investor's apportioned loss is subtracted from the money packet at step 128.

At step 130, the gain apportioned to the agent is credited to a reserve account of the agent.

A loss ends the combo. Once a combo ends due to a loss, the method provides an accounting and distribution of funds. The method uses data processing in an arithmetic logic circuit configuration to calculate the net gains or losses to the investor and the agent. An ongoing balance of investor earnings with packet total values is recorded and kept after each trade.

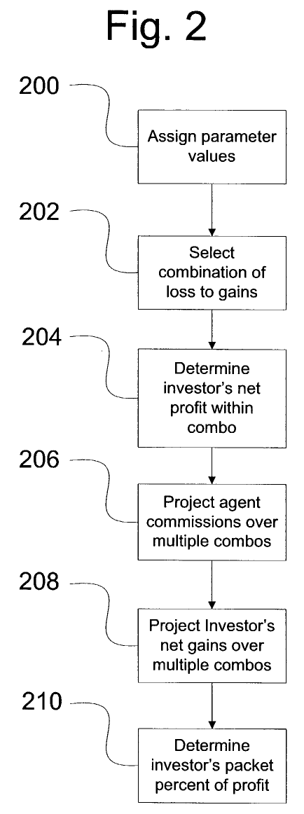

FIG. 2 shows a process flow diagram of operation of a method for performing a feasibility analysis to determine a positive packet percent of profit in the simulated investment of a money packet. A positive packet percent of profit indicates a gain.

In step 200, values are preliminarily assigned to parameters which are consequential to the outcome of the simulated investment. The values are chosen arbitrarily, but with a reasonable basis. That is, the values are chosen based on an analysis of historical stock data, such as the trends and stock data of a variety of general stocks. However, the parameter values are only approximations. If an investment is simulated and a loss is predicted by a negative percent of profit, the values for adjustable parameters are replaced with more conservative values that are more likely to achieve a gain. The investment can be simulated repeatedly until a gain is predicted by a positive packet percent of profit.

The values may either be fixed or adjustable, depending on which parameter they are assigned to. A fixed value cannot be changed throughout the simulated investment while an adjustable value may be changed repeatedly until the goal of the feasibility analysis is achieved. The values are either assigned by an agent, such as an investment broker, or are chosen by the investor. The parameters for which the values are assigned include packet investment, total investment, cost per share, profit percentage, stop-loss, commission, and investor gain and loss percentages.

The packet investment is a predetermined, but arbitrary investment sum which is divided into smaller units of investments, called packets. The packet investment is chosen by the investor. The investment of money is normally divided into equal packets. Preferably, the packets should be divided in units valued between $5,000 and $20,000.

A stock cost per share is then assigned by an agent. This is an arbitrarily assigned value that can later be adjusted. The value for the number of shares for the stock is assigned by dividing the packet investment by the cost per share. The number of shares is therefore dependent on the stock cost per share and the packet investment, and is adjustable.

Each packet is next assigned a gain sale threshold. The gain threshold is the profit percentage a stock must rise before it is sold. The gain sale threshold is an arbitrary value that may be changed. That is, if a stock should rise 4.3% for example, it would be sold. The agent assigns the gain sale threshold by performing a search of historical stock information and determining which reasonable values have been successful for stocks in general. For example, the agent may find that a gain sale threshold of 4.3% has historically resulted in gains for many stocks in general.

Next, stop-loss is assigned and is an automatic sell out if the shares fall a given percentage below the original purchase price. The stop-loss is a fixed value that is arbitrarily chosen by the agent.

Commission is also arbitrarily chosen by the agent and remains fixed. The commission is a fee paid to the agent for transacting the investment method of the present invention.

Each packet is also assigned a corresponding risk level number chosen by the investor. The agent assigns the investor's gain and loss percentages corresponding to the risk level chosen by the investor. For example, if the investor chooses risk level 3, the investor's gain apportionment is 100% and the investor's loss apportionment is 100% as shown in Table 1 above. These values remain unchanged once they are assigned.

In step 202, a combination of loss to gains per combo is selected. If the combo is a 1 gain to 1 loss combo, then every other trade is a loss. If the combo is a 2 gain to 1 loss combo, then every third trade is a loss.

In step 204, the investor's losses and gains are calculated within the combo to determine the net profit within the combo. Losses are determined in terms of a combined loss value. Gains are determined in terms of a net gain value.

The net gain value is determined from the trade profit, investor trade profit, and investor gain.

The trade profit is the amount of profit generated from the sale of a number of shares of stock at a particular gain sale threshold. The number of shares of stock is determined from the packet investment amount used to simulate the purchase of a stock and the cost per share of that stock. For example, if one money packet of $10,000 is invested to purchase a stock at $20 per share of the stock, there are 500 shares of the stock. The stock is sold when it reaches a particular gain sale threshold of for example 5%. The profit generated from the sale of 500 shares of the simulated stock is simply the gain sale threshold multiplied by the packet investment of $10,000.

The investor trade profit is the percentage of trade profit the investor keeps based on the gain apportionment percentage he has chosen in Table 1. If risk level 3 is chosen, then the investor gain apportionment is 100% of the trade profit, or $500. If however, risk level 2 is chosen, then the investor only receives 45% of the trade profits, or $225. Investor trade profit is calculated by multiplying the investor gain apportionment percentage by the trade profit.

The investor gain is the investor's gain after the agent's commissions have been deducted from the investor's trade profit. The investor gain is calculated by subtracting the agent's commissions from the investor trade profit.

The net gain is therefore the investor's gain within an entire combo. In step 202, a combination of loss to gains per combo was selected. If the combo selected in step 202 was a 1 gain to 1 loss combo, then the net gain is the investor's gain multiplied by the number of gains in the combo, namely one gain in the combo. Net gain is therefore determined by multiplying the investor gain times the number of gains in a combo.

The combined loss is the combination of loss and commissions paid to the agent. Loss is determined from the loss per share and stop-loss. The stop-loss is a preliminarily assigned value from step 200, indicating the value at which a stock is automatically sold if the stock falls a given percentage below the original purchase price. Loss per share is the amount each share is sold for when there is a stop-loss and an automatic sale of the stock. The loss per share is determined by multiplying the stop-loss value by the number of shares, indicating how much the stock has fallen below the original purchase price per share.

The loss is then determined from the loss per share and the number of shares of stock, by multiplying the loss per share by the number of shares of stock.

For example, if the stop-loss is 2%, or the stock has fallen 2% below the original purchase price, then the loss per share for 500 shares of stock for example, is $0.40. The loss per share of $0.40 multiplied by 500 shares of stock results in a loss of $200. The commission is arbitrarily chosen as some value such as for example $150. The combination of the loss of $200 and the arbitrarily chosen commission of $150 results in a combined loss value of $350.

The combo net profit is then determined by subtracting the combined loss from the net gain.

In step 206, the agent's commissions are projected over a multiple number of trades and combos. First, preliminary values are arbitrarily assigned for the number of investors and the number of combos in 12 months. For example, the number of investors may be 1000 investors and the number of combos in 12 months may be 15.

Then the total number of trades is determined by multiplying the total number of investors, the number of packets and the number of combo trades.

The number of packets is determined by how the investment sum of the preliminary assigned parameters is divided into packets. For example, if an investment sum of $30,000 is divided into three equal packet investments of $10,000, then there are 3 packets.

The number of combo trades is the sum of the combination of loss to gains in a combo. If there is a combined 2 gain to 1 loss, then the combo trade is 3.

The commission that an agent has chosen is then multiplied by the total number of trades to give the commission amount for the total number of trades, or total commissions.

The commission amount for the total number of trades, or total commissions is multiplied by the total number of combos in one year to give the commission amount over the total number of trades and combos, or combo commissions. The total amount of all commissions produced from the total number of trades in all combos over a 12 month period is thereby determined.

In step 208, the investor's net gains are projected over a multiple number of combos.

An arbitrarily chosen amount of combos over a 12 month period and the investor's combo net profit are used to determine the investor's one packet gain in dollars over the number of combos and the investor's packet percent of profit. The investor's one packet gain is determined by multiplying the investor's combo net profit by the arbitrarily chosen number of combos for 12 months.

In step 210, the investor's packet percent of profit is determined by dividing the packet gain by the packet investment.

A summary of equations for determining the packet percent of profit according to steps 200-210 is provided below in table 2:

TABLE 2

| Equation | Equation # |
|---|---|
| # of shares = Packet Investmen / Cost Per Share | 1 |
| Trade Profit = Packet Investment * Profit Percentage | 2 |
| Investor trade profit = Investor gain % * Trade profits | 3 |
| Investor Gain = Investor's profit − Commission | 4 |
| Net gain = # of gains in combo * Investor gain | 5 |
| Loss per share = stop-loss * # of shares | 6 |
| Loss = loss per share * # of shares | 7 |
| Combined loss = commissions + loss | 8 |
| Combo Net Profit = Net Gain − Combined Loss | 9 |
| Total trades = # of investors * # of packets * # of combo | 10 |
| trades | |
| Total Commissions = # of trades * commission | 11 |
| Combo Trades = # of combos * Total trades | 12 |
| Combo Commissions = # of combos * Total commissions | 13 |
| Packet Gain = Investor's combo net profit * # of combos | 14 |
| Packet Profit Percent = Packet Gain / Packet Investment | 15 |

### EXAMPLE 1

Referring now to table 3 below, the preliminarily assigned parameters of step 200 are summarized and exemplary values are shown for the parameters.

TABLE 3

| Item | Parameter | Value | Status |
|---|---|---|---|
| A | Packet Investment ($) | 10,000 | Fixed |
| B | Total Investment ($) | 30,000 | Fixed |
| C | Cost per share ($) | 20 | Adjustable |
| D | Gain sale threshold (%) | 4.3 | Adjustable |
| E | Stop-loss (%) | 2 | Fixed |
| F | Commission ($) | 150 | Fixed |
| G | Investor Gain Percentage (%) | 100 | Fixed |
| H | Investor Loss Percentage (%) | 100 | Fixed |

A combination of 1 gain to 1 loss in a combo is selected according to step 202 of the feasibility analysis method.

A summary of values and calculations is provided in Table 4 below for executing step 204 of the feasability analysis method to determine the net gain, combined loss, and combo net profit.

TABLE 4

| Parameter | Value | Calculation | Equation # |
|---|---|---|---|
| # of shares | 500 | 10,000 / 20 | 1 |
| Trade Profit ($) | 430 | 10,000 * 4.3% | 2 |
| Investor Trade Profit ($) | 430 | 100% * 430 | 3 |
| Investor Gain ($) | 280 | 430 − 150 | 4 |
| Net Gain ($) | 280 | 1 * 280 | 5 |
| Loss per share at 2% stop-loss ($) | 0.4 | 20 * 2% | 6 |
| Loss at 2% stop-loss ($) | 200 | 0.4 * 500 | 7 |
| Combined Loss ($) | 350 | 150 + 200 | 8 |
| Combo Net Profit ($) | −70 | 280 − 350 | 9 |

Table 5 below shows example calculations for projecting the agent's commissions over multiple numbers of trades and combos according to step 206.

TABLE 5

| Parameter | Value | Calculation | Equation # |
|---|---|---|---|
| # of investors | 1000 | N/A | N/A |
| # of combos (1 year) | 26 | N/A | N/A |
| # of packets | 3 | N/A | N/A |
| Total Trades | 6000 | 1000 * 3 * 2 | 10 |
| Total Commissions ($) | 900,000 | 6000 * 150 | 11 |
| Combo Trades | 156,000 | 26 * 6000 | 12 |
| Combo Commissions ($) | 23,400,000 | 26 * 900,000 | 13 |

Table 6 summarizes exemplary values and calculations for determining the net results of an investor's gains based on multiple projections according to step 208.

TABLE 6

| | | | |
|---|---|---|---|
| Parameter | Value | Calculation | Equation # |

| | | | |
|---|---|---|---|
| # of Combos | 26 | N/A | N/A |
| Packet Gain ($) | −1,820 | −70 * 26 | 17 |
| Packet Profit Percent (%) | −18.20 | −1,820 / 10,000 | 18 |

As shown in Tables 4 and 6, the Combo net profit and the Packet Gain and Packet Profit are negative. Therefore, a loss occurs based on the preliminary values assigned for the parameters in Table 2. However, a gain is being sought. Therefore, the preliminary gain sale threshold from Table 1 can be adjusted in an attempt to achieve a gain. Steps 202-210 are performed again with the adjusted gain sale threshold. If a loss still occurs, the preliminary gain sale threshold can be changed again. This adjustment of the gain sale threshold is continuously performed until a gain, or positive percent of profit is reached. In example 2 below, Table 7 shows preliminary values with a gain sale threshold of 5.8 and Table 8 shows a gain in the packet profit percent based on a preliminary gain sale threshold of 5.8%. Therefore, the goal of the feasibility analysis method is achieved in example 2.

### EXAMPLE 2

TABLE 7

| Parameter | Value |
|---|---|
| Packet Investment ($) | 10,000 |
| Total Investment ($) | 30,000 |
| Cost per share ($) | 20 |
| Gain sale threshold (%) | 5.8 |
| Stop-Loss (%) | 2 |
| Commission ($) | 150 |
| Investor Gain Percentage (%) | 100 |
| Investor Loss Percentage (%) | 100 |

TABLE 8

| Parameter | Value | Calculations | Equation # |
|---|---|---|---|
| # of shares | 500 | 10,000 / 20 | 1 |
| Trade Profit ($) | 580 | 10,000 * 5.8% | 2 |
| Investor Trade Profit ($) | 580 | 100% * 580 | 3 |
| Investor Gain ($) | 430 | 580 − 150 | 4 |
| Net Gain ($) | 430 | 1 * 430 | 5 |
| Loss per share at 2% | 0.4 | 20 * 2% | 6 |
| stop-loss ($) | | | |
| Loss at 2% stop-loss ($) | 200 | 0.4 * 500 | 7 |
| Combined Loss ($) | 350 | 150 + 200 | 8 |
| Combo Net Profit ($) | 80 | 430 − 350 | 9 |
| # of investors | 1000 | N/A | N/A |
| # of combos (1 year) | 26 | N/A | N/A |
| Total Trades | 6000 | 1000 * 3 * 2 | 10 |
| Total Commissions | 900,000 | 6000 * 150 | 11 |
| Combo Trades | 156,000 | 26 * 6000 | 12 |
| Combo Commissions ($) | 23,400,000 | 26 * 900,000 | 13 |
| One Packet Gain ($) | 2,080 | 80 * 26 | 14 |
| Packet Profit Percent (%) | 20.80 | 2,080 / 10,000 | 15 |

However, the preliminary gain sale threshold is not the only value that can be adjusted in order to achieve the goal of the feasibility analysis method. For example, the combination of gains and losses in a combo may also be changed to for example 2 gains to 1 loss. The feasibility analysis method can then be executed again to determine a new packet percent of profit and assess whether it is a gain or a loss.

In an alternative embodiment of the feasibility analysis, the investor may choose a risk level similar to risk level 1 in table 1 above. Risk level indicates a gain sale threshold of 4, a loss sale threshold of 2, a gain apportionment of 12% and a loss apportionment of 0%. Therefore, the investor is guaranteed no loss by a 0% loss apportionment. Furthermore, the agent is not paid commissions due to the gain and loss apportionment. Therefore, the agent is not entitled to commissions from the investors profits.

However, the agent can still withdraw commissions from his reserve account. When an investor chooses a risk level in which his gain apportionment entitles a recovery of only a fraction of the trade profits (e.g., 12% gain apportionment according to risk level 1 of table 1), the remaining fraction of unrecovered trade profits is placed in the agent's reserve account, which he may use at his discretion. For example, he may take funds from the reserve account in an amount equal to what he would normally receive for commissions, and then calculate the projected value of those commissions when applied to multiple trades and combos.

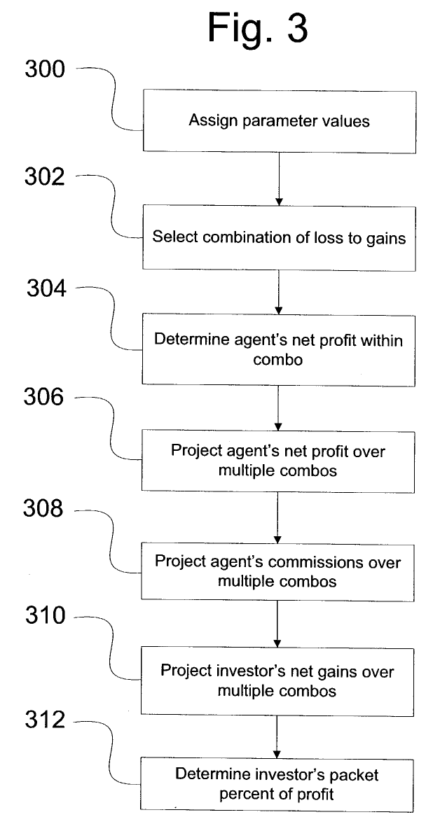

FIG. 3 shows a process flow diagram of operation of a method for performing a feasibility analysis to determine whether a gain sale threshold is practical and most likely to produce a gain, as well as what total commissions an agent will receive if he draws his standard commission fee from a reserve account. Such a determination is also made by simulating an investment of a money packet.

In step 300, values are preliminarily assigned to parameters which are consequential to the outcome of the simulated investment. The values are chosen arbitrarily, but with a reasonable basis. That is, the values are chosen based on an analysis of historical stock data, such as the trends and stock data of a variety of general stocks. The parameters for which the values are assigned include packet investment, total investment, cost per share, profit percentage, stop-loss, commission, and investor gain and loss percentages.

In step 302, a combination of loss to gains per combo is selected. If the combo is a 1 gain to 1 loss combo, then every other trade is a loss. If the combo is a 2 gain to 1 loss combo, then every third trade is a loss

In step 304, the agent's combined loss and net gain are calculated within the combo to determine the agent's net combo profit. The investor's gains and losses are not needed for determining an investor combo net profit in this embodiment of the invention because the investor has a no-loss assurance in risk level 1. The investor's combo net profit is derived solely from the gain apportionment of the trade profit (e.g., investor profit). However, the agent may gain the remaining fraction of the trade profits unclaimed by the investor who only has a 12% gain apportionment for example. The agent also has losses by withdrawing from his reserve account. Therefore, in this alternative embodiment, step 304 requires that the losses and gains for the agent be determined.

The commission derived from the reserve account is considered a loss as already mentioned. In order to determine the combined loss for the agent, the commission derived from the agent must be added to the losses that are absorbed by the agent. The agent must absorb all losses because the investor has chosen a no loss assurance risk level. The stop-loss and loss per share for a stock are used to determine the loss that the agent must absorb. The loss per share is determined by multiplying the stop-loss value by the number of shares, indicating how much the stock has fallen below the original purchase price per share. The loss is then determined from the loss per share and the number of shares of stock, by multiplying the loss per share by the number of shares of stock.

Therefore, if the stop-loss is for example 2% and the number of shares, determined from the money packet value and the cost per share value, is 500 shares, then the loss per share is 0.40. The loss then is determined by multiplying the loss per share of 0.40 by the 500 shares of stock. The loss would be $200 according to this example. Once the loss is determined, it is simply added to the commission that the agent draws from the reserve account. That is, if the commission withdrawn per combo transaction is $150, and the loss is $200, then the combined loss for the agent is $350.

The agent's net gain value is determined from the trade profit, investor trade profit, and the agent commission drawn from the reserve account. The agent gains all profits not collected by the investor. If the investor has a chosen a 12% gain apportionment according to risk level 1, then the investor receives 88% of the trade profits in his reserve account, or the remaining unrecovered trade profits. However, because the agent also draws commissions from the reserve account, the agent's standard commission fee per combo transaction must be deducted from the agent's reserve account 88% trade profit gain.

For example, if the trade profits are determined from multiplying the money packet investment of $10,000 by the gain sale threshold of 5.8%, the trade profit is determined to be $580. The investor can only recover $70 or 12% gain apportionment as the investor's profit. The remaining 88%, or $510, goes to the agent's reserve account. The agent withdraws a $150 standard commission fee for each combo transaction. Therefore, the agent's net gain is $360.

The agent's combo net profit is determined from the combined loss and net gain by subtracting the combined loss from the net gain.

In step 306, the agent's combo net profit in his reserve account is projected over a multiple number of trades and combos to determine the total reserve profit. First, preliminary values are arbitrarily assigned for the number of investors and the number of combos in 12 months. For example, the number of investors may be 1000 investors and the number of combos in 12 months may be 15.

The agent's combo net profit is then multiplied by the total number of packets, investors and combos to give the agent's profit in his reserve for the total number of trades and combos.

In step 308, the agent's commissions that have been withdrawn from the reserve are projected over a multiple number of trades and combos. Preliminary values for the number of investors and the number of combos in 12 months have already been arbitrarily assigned in step 306 and the same values are used for step 308.

Then the total number of trades is determined by multiplying the total number of investors, the number of packets and the number of combo trades.

The commission that an agent has withdrawn from the reserve is then multiplied by the total number of trades to give the commission amount for the total number of trades.

The commission amount for the total number of trades is multiplied by the total number of combos in one year to give the commission amount over the total number of trades and combos. The total amount of all commissions produced from the total number of trades in all combos over a 12 month period is thereby determined.

In step 310, the investor's net gains are projected over a multiple number of combos.

An arbitrarily chosen amount of combos over a 12 month period and the investor's profit is used to determine the investor's one packet gain in dollars over the number of combos and the investor's packet percent of profit. Only the investor's trade profit is needed because the investor has a no-loss assurance with a 0% loss apportionment. The investor's one packet gain is determined by multiplying the investor's profit by the arbitrarily chosen number of combos for 12 months.

In step 312, the investor's packet percent of profit is determined by dividing the packet gain by the money packet investment.

A summary of additional equations for calculations for the second embodiment of the feasibility analysis is provided below in table 9:

TABLE 9

| Equation | Equation # |
|---|---|
| Agent Gain = Agent Profit * Trade profits | 16 |
| Agent Net Gain ($) = Agent gain − commission | 17 |
| Agent loss per share = cost per share * stop-loss | 18 |
| Agent Loss = agent loss per share * # of shares | 19 |
| Agent Combined Loss = agent loss + commission | 20 |
| Agent Combo Net Profit = agent net gain − agent combined | 21 |
| loss | |
| Total Reserve Profit = Agent combo net profit * | 22 |
| # of investors * # of combos * # of packets | |
| One Packet Gain = Investor's Trade Profit * # of combos | 23 |

### EXAMPLE 3

Tables 10 and 11 demonstrate exemplary calculations and values for performing steps 300-312.

TABLE 10

| Parameter | Value |
|---|---|
| Packet Investment ($) | 10,000 |
| Total Investment ($) | 30,000 |
| Cost per share ($) | 20 |
| Gain sale threshold (%) | 5.8 |
| Stop-Loss (%) | 2 |
| Commission ($) | 150 |
| Investor Gain Percentage (%) | 12 |
| Investor Loss Percentage (%) | 0 |

TABLE 11

| Parameter | Value | Calculations | Equation # |
|---|---|---|---|
| # of shares | 500 | 10,000 / 20 | 1 |
| Trade Profit ($) | 580 | 10,000 * 5.8% | 2 |
| Investor Trade Profit | 70 | 12% * 580 | 3 |
| ($) | | | |
| Agent Gain ($) | 510.40 | 88% * 580 | 16 |
| Agent Net Gain ($) | 360.4 | 510.40 − 150 | 17 |
| Agent loss per share | 0.4 | 20 * 2% | 18 |
| Agent Loss at 2% | 200 | 0.4 * 500 | 19 |
| stop-loss ($) | | | |
| Agent Combined Loss | 350 | 150 + 200 | 20 |
| ($) | | | |
| Agent Combo Net | 10.40 | 360.40 − 350 | 21 |
| Profit ($) | | | |
| # of investors | 1000 | N/A | N/A |
| # of combos (1 year) | 26 | N/A | N/A |
| Total Reserve Profit | 811,200 | 10.40 * 1000 * 26 * 3 | 22 |
| Total Trades | 6000 | 1000 * 3 * 2 | 10 |
| Total Commissions | 900,000 | 6000 * 150 | 11 |
| Σ Combo Trades | 156,000 | 26 * 6000 | 12 |
| Σ Combo | 23,400,000 | 26 * 900,000 | 13 |
| Commissions ($) | | | |
| One Packet Gain ($) | 1,820 | 70 * 26 | 23 |
| Packet Profit Percent | 18.20 | 1,820 / 10,000 | 15 |
| (%) | | | |

In a third embodiment, the investment sum is divided into a plurality of money packets. A different level of investment can be selected for each money packet. This provides the investor the possibility of choosing different levels of risk for each money packet.

The investment system of the present invention utilizes a server, an investor terminal and an agent terminal. The server and agent terminal can be coupled using multiple access methods, including a local or wide area network, Intranet, Internet, leased communication lines or dial-up telephone lines, or some combination thereof.

The investor terminal is not necessarily hard-wired to the server. The server can be accessed by the investor through the Internet, leased communication lines or dial-up telephone lines, or some combination thereof.

Server

A server includes a database and a data processor operating under control of an operating system and application software. The server responds to messages from the agent terminal and the investor terminal. The data processor may comprise a microprocessor, for example, an Intel Pentium processor, a mini-computer or mainframe processor.

The server accepts investor information from the investor and agent terminals, compares the sale gain threshold with projected values of equities, and sends information based on the comparison to the sender terminal.

The database stores and segregates levels of investment profiles, and for each level of investment profile, a gain apportionment value, a loss apportionment value, a gain sale threshold and a loss sale threshold.

The gain apportionment value, a loss apportionment value, gain sale threshold, and loss sale threshold have been pre-designated and selected by the agent for each level of investment. The number of apportionment values and sale thresholds which can be used by the system are virtually limitless.

The server, in a preferred embodiment of the invention, includes a set of program modules. Each module is a set of software objects and/or program elements, collectively having the ability to execute independently in a separate thread or logical chain of process execution. Each module can be executed as a separate logical server or using a separate physical device.

The server preferably includes a login module, an investor module and an agent module. The login module is responsible for password checking, access control, and assignment of a particular program module to service the investor.

The investor module handles all server-side application requirements of the investor terminal. The agent module handles all server-side application requirements of the agent terminal.

Investor Terminal

The investor terminal comprises a device or set of devices coupled to the server, such as a general purpose processor operating under control of operating system and application software, and disposed to enter and process information, as described herein. In a preferred embodiment, the investor terminal can comprise a PC workstation such as an Intel Pentium processor operating under control of the Microsoft Windows operating system.

The investor terminal includes information input devices, such as a keyboard and mouse or other pointing device, and information output and presentation devices, such as a monitor and printer.

An investor uses the investor terminal to access from the server the level of investment profiles, to select a level of investment profile, and to monitor transactions and the balance in the investor's account.

The investor cannot access the server without entering an authorized code or password.

Agent Terminal

The agent terminal comprises a device or set of devices coupled to the server terminal, such as a general purpose processor operating under control of operating system and application software. In a further preferred embodiment, the agent terminal can comprise a PC workstation such as an Intel Pentium processor operating under control of the Microsoft Windows operating system.

The agent terminal includes information input devices, such as a keyboard and mouse or other pointing device, and information output and presentation devices, such as a monitor and printer.

A agent uses the agent terminal to transmit level of investment profiles and instructions to sell a purchased equity to the server terminal, and to access an investor's selection of a level of investment and account balance information.

The feasibility analysis can be performed by a computing means capable of calculating data based on assigned data. The computing means should have a database for storing information, and most preferably, a relational database, containing information organized by its relation to other information, as opposed to data organized in fields without relation to other fields. A processor is also needed for carrying out designated calculations. The computing means carries out a number of steps in sequential order including a first step of allowing the input and storage of assigned parameter values such as for example, gain sale threshold, cost per share, or commission. Then the computing means executes equations 1-23 above by simply inputting the assigned values in the order presented above.

Alternatively, a programmed operation can be set up using an electronic chart or computer spreadsheet. The chart may have certain fields which contain assigned parameter values and other fields in which data is outputted after the processing of steps and calculations based on programmed operations within the chart.

While a specific embodiment of the invention has been shown and described in detail to illustrate the application of the principles of the invention, it will be understood that the invention may be embodied otherwise without departing from such principles.

What is claimed is:

1. A method for an investor to invest a money packet, with the aid of an agent, and with a controlled loss assurance, the method comprising the steps of:
a. providing a plurality of risk levels, each risk level having a gain apportionment value which dictates apportionment of a gain between the investor and the agent, and a loss apportionment value which dictates apportionment of a loss between the investor and the agent, at least one of the risk levels having a non-zero apportionment of loss to the agent,
b. selecting one of said risk levels having a non-zero apportionment of loss to the agent;
c. performing a feasibility analysis to determine a positive packet percent of profit in a simulated investment by assigning a predetermined gain sale threshold value and values for other parameters that are consequential to an investment outcome, selecting a combination of loss to gains per combo, determining an investor's combo net profit, projecting said investor's combo net profit over a plurality of combos, and using said projected combo net profit to determine a percent of profit for said money packet, and adjusting said predetermined gain sale threshold value or said selected combination of loss to gains per combo if a negative packet percent of profit is determined;
d. determining whether a specific equity can conform to said predetermined gain sale threshold assigned in the feasibility analysis;
e. purchasing an equity with the money packet;
f. upon reaching a gain sale threshold or loss sale threshold, selling all of the purchased equity to complete a cycle of a combo;
g. if the sale threshold reached is a gain sale threshold, apportioning the gain between the investor and the agent according to the gain apportionment value of the selected risk level; adding the investor's apportioned gain to the money packet; and repeating steps d. to f. until the sale threshold is a loss sale threshold, wherein the loss sale threshold ends the combo;
h. apportioning the loss between the investor and the agent according to the loss apportionment value of the selected risk level; and
i. subtracting the investor's apportioned loss from the money packet.

2. The method according to claim 1, wherein the equity has a projected value corresponding to the gain sale threshold of the selected risk level.

3. The method according to claim 1, wherein the risk levels comprise a low risk level, a medium risk level and a high risk level.

4. The method according to claim 3, wherein for the low risk level, no loss is apportioned to the investor.

5. The method according to claim 3, wherein for the high risk level, 100 percent of the gain and 100 percent of the loss are apportioned to the investor.

6. The method according to claim 1, further comprising the step of projecting an agent's commissions over a plurality of trades and combos determine whether the agent's commissions are positive.

7. The method according to claim 1, further comprising a step of crediting a reserve account with the gain apportioned to the agent.

8. A method for performing a feasibility analysis to determine a packet percent of profit that is positive, comprising the steps of:
dividing an investment sum into a plurality of packets;
assigning values for fixed and adjustable parameters that are consequential to an investment outcome;
selecting a combination of loss to gains per combo;
determining an investor's combo net profit;
projecting said investor's combo net profit over a plurality of combos; and
using said projected combo net profit to determine a percent of profit for said money packet.

9. A method according to claim 8, wherein a gain sale threshold is an adjustable parameter.

10. A method according to claim 8, wherein the selected combination of loss to gains per combo can be adjusted.

11. A method according to claim 9, wherein if said percent of profit is a negative value, then said gain sale threshold parameter is adjusted and said steps for determining a packet percent of profit that is positive, are repeated.

12. A method according to claim 10, wherein if said percent of profit is a negative value, then said selected combination of loss to gains per combo is adjusted and said steps for determining a packet percent of profit that is positive, are repeated.

13. A method according to claim 8, further comprising the step of projecting an agent's commissions over a plurality of trades and combos determine whether the agent's commissions are positive.

14. A computer system for determining a packet percent of profit with a positive value, comprising:
a database for storing assigned parameters;
a processing means for calculating equations; and
a programmed operation stored on said database that can be accessed by said processing means, wherein steps are executed in a particular order according to the programmed operation;
the steps executed by the processing means in the order of first dividing an investment sum into a plurality of equal packet units, then assigning values for fixed and adjustable parameters that are consequential to an investment outcome; then selecting a combination of loss to gains per combo; then determining an investor's combo net profit; then projecting said investor's combo net profit over a plurality of combos; and then using said projected combo net profit to determine a percent of profit for said money packet.

15. A computer system according to claim 14, wherein said assigned parameters include a gain apportionment and a loss apportionment chosen by an investor and derived from a plurality of risk level profiles stored in said database, the risk levels comprising a low risk level, a medium risk level and a high risk level.

16. The computer system according to claim 15, wherein for the low risk level, no loss is apportioned to the investor.

17. The computer system according to claim 15, wherein for the high risk level, 100 percent of the gain and 100 percent of the loss are apportioned to the investor.

18. A method according to claim 15, wherein if said percent of profit is a negative value, then adjustable parameters are adjusted and said steps executed by the processing means for determining a percent of profit that is positive, are repeated.

19. A method according to claim 15, further comprising the step of projecting an agent's commissions over a plurality of trades and combos determine whether the agent's commissions are positive.
